(19) United States
(12) Patent Application Publication
(10) Pub. No.: US 2007/0286429 A1
(43) Pub. Date: Dec. 13, 2007

(54) Compact test apparatus for hearing device

(75) Inventors: Esfandiar Grafenberg, Effeltrich (DE); Harald Klemenz, Furth (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GbmH

(21) Appl. No.: 11/810,975

(22) Filed: Jun. 7, 2007

(30) Foreign Application Priority Data
Jun. 8, 2006 (DE) 10 2006 026 721.4

(51) Int. Cl. H04R 29/00

(52) U.S. Cl. 381/60; 381/312

(57) ABSTRACT

An apparatus for testing of a hearing device is described, which includes the following components:

a housing with a test area embodied to accommodate a hearing device, with the test area including a microphone area and an earpiece area,

a signal generator and a loudspeaker, to create a defined acoustic test signal in the microphone area,

a microphone arranged in the earpiece area to detect an acoustic response signal emitted by the hearing device,

an evaluation circuit to assess the functional state of the hearing device on the basis of the response signal, and

a display device to display the functional state of the hearing device.

### CROSS REFERENCE TO RELATED APPLICATIONS

This application claims priority of German application No. 10 2006 026 721.4 DE filed Jun. 8, 2006, which is incorporated by reference herein in its entirety.

### FIELD OF INVENTION

Hearing devices serve to restore or improve the hearing capabilities of those with impaired hearing. Different types of hearing device are employed in such cases.

### BACKGROUND OF INVENTION

The most widespread are the so-called BTE (behind-the-ear) devices which are worn behind the ear. They are suitable for almost all types of hearing impairment. In addition there are ITE (in-the-ear) devices as well hearing aid eyeglasses. Apart from their different external embodiments, all hearing devices typically feature the same technical components, namely a microphone, an earpiece, an amplifier circuit and also a battery. In addition specific circuits such as filter circuits are used, with the aid of which the sound can be modulated and thus adapted to the individual needs of those involved. Digital hearing devices are also known, in which the audio signals are processed with the aid of microprocessors (DSP processors). This enables the sound to be far better adapted to the individual requirements.

Hearing devices not only have the task of bringing the sound amplified to the ear. Since as a rule not all frequencies are affected equally with a hearing impediment, the frequency response of a modern hearing device is adapted to the respective hearing loss using numerous adjustment options. The adaptation is generally undertaken in collaboration with the doctor and the hearing aid acoustic specialist. Regular visits to the hearing aid acoustic specialist as well as check-up examinations at the doctor are necessary to guarantee the operability of hearing device and an optimum adaptation.

Furthermore the hearing devices must be maintained and looked after in day-to-day use service by their wearers, since the hearing device adjusted on the basis of an individual audiogram can be affected by different factors, such as dirt or damage for example. As a result of this the sound of the hearing device can be distorted, noisy or disturbed in some other way.

In particular contamination of the hearing device, e.g. sweat or the cerumen to be found especially in the outer auditory canal, can reduce the sound quality of the hearing device. Such contamination is above all critical at the microphone openings since it can frequently not be detected by a simple visual inspection. The distortions arising from these causes can also often not be perceived by those affected, especially when they occur progressively and, because of the subjective perception of those involved, are not appropriate for producing the feeling of a deterioration in sound.

It may thus be necessary for the user to check and maintain the hearing device several times a day. Small children in particular are frequently not able to establish malfunctions or distorted reproduction of the hearing device themselves and rectify it where necessary. The parents must carry out the checking of the hearing device here for example.

The functions of hearing devices are conventionally checked using what is known as a stethoclip. The stethoclip, a sort of stethoscope, is plugged into the ear hook of the hearing device and allows the helper to be aware of the sound created by the earpiece of the hearing device while they are speaking into the microphone of the hearing device for example.

An assessment of the function of the hearing device by means of a stethoclip is however very subjective. Furthermore not all malfunctions can be detected since only a part of the frequency spectrum can be tested with the speech selected for the test.

A storage case for hearing devices is known from DE 103 54 897 B4 in which a self-test of a hearing device can be executed in order for example to detect contamination of the sound outlet openings of the hearing device with cerumen. To perform a self-test the hearing device creates acoustic signals via its loudspeaker which are received again via the microphone of the hearing device. The evaluation is undertaken in the hearing device itself, which demands a specially embodied hearing device. Since the case merely accommodates the hearing device as well as providing the acoustic path between the loudspeaker and the microphone of the hearing device, the ability to execute the test depends above all on the operability of the hearing device and its components. To execute the self-test it is necessary to activate the hearing device accordingly. In addition further apparatus is required for evaluating or displaying the test. This all demands specific knowledge and abilities, making the test system not suitable for all users.

A device, which features a number of holders for accommodating one hearing device is each case, for demonstrating the characteristics and transmission qualities of different hearing devices is known from DE 196 33 996 B4. A loudspeaker and a microphone are each arranged in the area of a holder so that a hearing device placed in the holder receives via its hearing device microphone an acoustic signal from the loudspeaker of the device and can transmit it again via the hearing device loudspeaker back to the microphone of the device. The device merely serves to demonstrate different hearing devices and their transmission characteristics and because of its embodiment is not suitable for testing a hearing device.

EP 1 251 716 B1 discloses a method for modeling converters of digital hearing devices with the aid of a special test apparatus. In this case the hearing device microphone and the hearing device loudspeaker can also be tested. Since the test apparatus uses facilities such as a computer, a certain level of knowledge and ability is required to use it, which once again greatly restricts the applicability of the test apparatus.

### SUMMARY OF INVENTION

Using this prior art as its starting point, an object of the invention is to provide a device with the aid of which the function of a hearing device can be tested very simply. This object is achieved by a device with the features of an independent claim. Further advantageous embodiments of the invention are specified in the dependent claims.

In accordance with the invention, a device for testing a hearing device is provided featuring a housing with a test area for accommodating a hearing device, with the test area including a microphone area and an earpiece area. Furthermore a signal generator and a loudspeaker are provided in order to create a defined acoustic test signal in the microphone area. In addition a microphone is arranged in the earpiece area, in order to detect an acoustic response signal output by the hearing device. An evaluation circuit is provided to assess the functional state of the hearing device on the basis of the response signal. The functional state of the hearing device is finally displayed on a display device. With the aid of the test apparatus the functional state can be objectively assessed very simply and automatically.

In an advantageous embodiment of the invention the display device is embodied to display the functional state optically and/or acoustically. The optical display in particular allows the test result to be easily checked.

A further advantageous embodiment of the invention makes provision for the display device to feature a first light source to indicate the functional state “test passed“and a second light source to indicate the functional state “test not passed”. This enables a unique indication to be provided of whether the hearing device is functioning or not.

In an especially advantageous embodiment of the invention there is provision for a green light emitting diode to be used as the first light source and for a red light emitting diode to be used as second light source. Since the significance of these colors is generally known, the operation of the device can be simplified in this way.

It is especially advantageous for the signal generator to generate noise as a test signal. This noise contains a plurality of frequencies. This enables the evaluation to include frequencies from the entire sound spectrum.

An especially simple evaluation circuit includes a comparator which assesses the functional state of the hearing device on the basis of a comparison between the amplitude of the response signal and a predetermined voltage value. As standard components such comparators are especially useful.

In a further advantageous embodiment of the invention the evaluation circuit assesses the functional state of the hearing device on the basis of a comparison between the test signal and the response signal. This allows undesired deviations in the signal processing of the hearing device to be detected particularly easily.

An advantageous embodiment of the invention provides for the earpiece area and the microphone area to be acoustically screened from each other. Disturbing feedback is avoided in this way and thereby a more precise measurement made possible. It is advantageous in this case to model the earpiece area on the earpiece of the hearing device in order to accommodate the earpiece using a positive and/or non-positive fit and thus screen it acoustically from the microphone area.

It is especially advantageous to embody at least a part of the housing as a sound-deadening area. The hearing device is acoustically screened from its environment in this way. The function test runs without being disturbed.

In order to also test the hearing device under realistic conditions, the housing is embodied at least partly flexibly in the test area. This allows a hearing device arranged in the test area to be mechanically stressed from outside as a function test is being conducted.

It is further advantageous to embody the housing as a storage box for the hearing device. This provides a test apparatus which is always carried with the hearing device wearer.

### BRIEF DESCRIPTION OF THE DRAWINGS

The invention is described in greater detail below with reference to drawings.

The figures show:

FIG. 1 an inventive device for testing the function of a hearing device with a compact housing and a hearing device arranged in the test apparatus; and

FIG. 2 the typical internal layout of an inventive test apparatus.

### DETAILED DESCRIPTION OF INVENTION

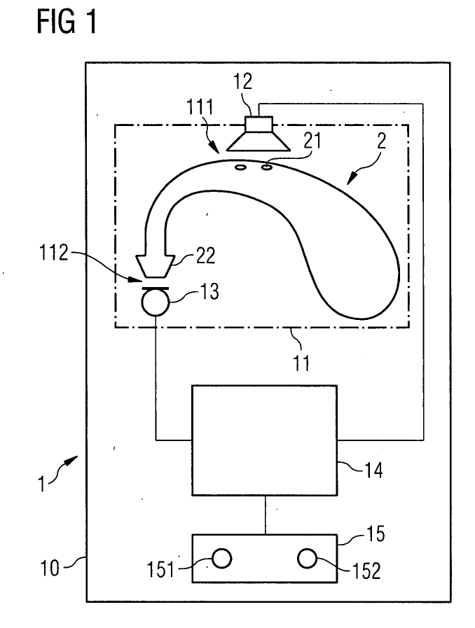

FIG. 1 shows an example of an inventive test apparatus 1 with a hearing device 2 arranged in it. Preferably this test apparatus 1 is embodied as a compact pocketable unit in the form of a simple test box so that users can always carry it with them. The housing 10 of the test apparatus features an area to accommodate a hearing device 2, referred to below as the test area 11. This test area 11 can be specifically adapted to accommodate a particular hearing device. Preferably the accommodation area 11 features special cutout shapes which correspond to the relevant hearing device 2. To fix the hearing device 2 in a predetermined position in the test apparatus 1 further retaining devices can be provided (not shown here).

The test area 11, only shown by a dashed line in FIG. 1, includes a microphone area 111 and an earpiece area 112. These areas are preferably arranged so that, when a corresponding hearing device 2 is placed in the holder, the hearing device microphone 21 lies in the microphone area 111 and the earpiece 22 of the hearing device lies in the earpiece area 112. To clarify this arrangement, FIG. 1 shows a hearing device 2 already arranged in the test area 11.

An acoustic signal generator, preferably a loudspeaker 12, is arranged in the microphone area 111 so that it outputs sound directly to the microphone openings 21 of a hearing device 2 arranged in the test apparatus. A test microphone 13 is provided in the earpiece area 112 which is preferably arranged so that it lies directly in front of the earpiece opening 22 of the hearing device 2 arranged in the test apparatus. Sound is supplied directly to the test microphone 13 in test mode by the earpiece 22 of the hearing device 2.

Both the loudspeaker 12 and also the test microphone 13 are connected to an electronic test circuit 14, shown in simplified form in FIG. 1 as a block. This test circuit 14 includes a sound generator 141 and an evaluation circuit 144. The sound generator 141 creates a defined acoustic test signal which is reproduced via the loudspeaker 12 at the hearing device microphone 21. The evaluation circuit 144 is used for the evaluation of the response signal of the hearing device 2 received by the test microphone 12.

The test apparatus 1 further features a display device 15, preferably embodied as an optical display. The display device 15 is used to display the functional state of the hearing device 2 determined on the basis of the response signal. As is shown in FIG. 1 the display device 15 merely has two small lamps 151, 152 for this purpose, with which it can be indicated whether the function test has been passed or not passed respectively. It is especially advantageous to use a green and a red light emitting diode, with the red light emitting diode indicating “function test not passed” while the green light emitting diode indicates “function test passed”.

The test apparatus 1 shown in FIG. 1 is typically embodied to accommodate what is known as a BTE device 2. With such a BTE device, microphone, earpiece and amplifier are accommodated in a housing which is worn behind the ear. The sound passes from the earpiece via the ear support hook and an otoplastic into the auditory canal. The functions of such a device 2 are preferably tested without the associated support hook, with the test microphone 13 being arranged directly at the earpiece output 22 of the hearing device 2. Alternatively however it is also possible to arrange the test microphone 13 so that a function test of the hearing device 2 can be undertaken including the support hook and if necessary including the otoplastic. A corresponding design of the test area 11 is sensible in this case, to guarantee a fixing of the support hook or of the otoplastic respectively at a defined distance from the test microphone 13.

The housing 10 of the test apparatus 1 is preferably embodied to enable it to accommodate the entire hearing device 2. It is especially advantageous for the hearing device 2 to be acoustically isolated from its environment during function testing. To this end it is necessary for the test apparatus housing 2 to completely enclose the hearing device 2 arranged in the test area 11. To this end the test apparatus 1 can for example be equipped with a hinge mechanism, with the test apparatus 1 being closed after the insertion of the hearing device 2 and the hearing device 2 thus soundproofed. Alternatively a sliding mechanism is also conceivable. To improve the function test and if necessary to avoid feedback, it can further be necessary to acoustically isolate the microphone area 111 from the earpiece area 112. To this end for example special Silicon or foam cushions can be arranged in the test area 11, so that, with a hearing device 2 inserted and the test apparatus housing 10 closed, an acoustic separation is obtained between the two areas. It is further possible to model the earpiece area 112 on the earpiece 22 of the hearing device 2 such that the latter can be fixed in the earpiece area 112. In this case both a positive-fit fixing and a non-positive-fit fixing are conceivable. By using elastic materials the earpiece area 112 can be suitably acoustically isolated from the rest of the test area 11.

To also detect such malfunctions in the hearing device 2 as only arise under specific conditions, especially with particular mechanical stresses, such as an interruption by damage to an earpiece suspension unit or a loose contact, it is sensible to simulate these conditions during the function test. To this end the housing 10 of the test apparatus 1 is preferably embodied flexibly in at least in a part of the test area 11, so that the hearing device 2 can be mechanically stressed during a function test by mechanical pressure on the flexible part of the housing 10. This can be implemented by the use of a flexible plastic material which is simultaneously suitably soundproof.

As is illustrated in FIG. 1, the microphone 21 of the hearing device 2 is corrected because of the specific arrangement through the test loudspeaker 12 directly to an acoustic test signal. The test microphone 13 subsequently receives at the earpiece 22 of the hearing device 1 the response signal produced by the hearing device 2 and directs it for evaluation to the test circuit 14.

The test apparatus shown in FIG. 1 is preferably embodied as a storage or transport box for the corresponding hearing device 2. Further it is possible to provide the test apparatus 1 for a pair of hearing aids. To keep the design of the test apparatus as simple as possible, it is advantageous for the test circuit or also the test loudspeaker to be jointly used by both hearing devices.

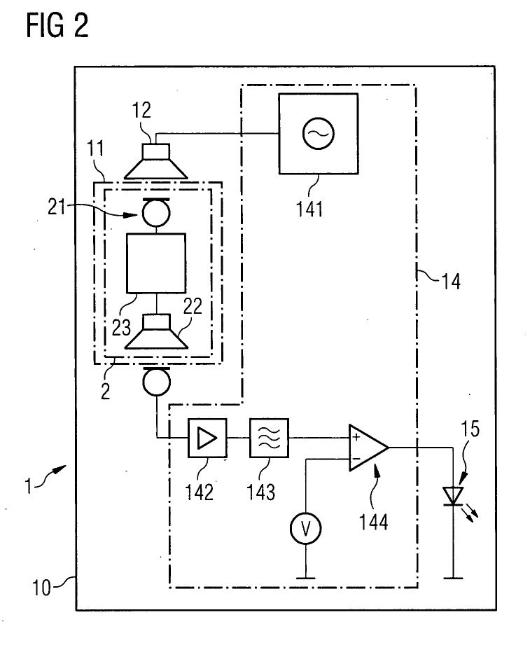

The internal layout of the test circuit of the inventive test apparatus shown in FIG. 1 simply as a block is explained below in more detail below with reference to FIG. 2. As already stated, the test loudspeaker 12 is connected to a sound generator 141 which generates a predetermined test signal. Preferably noise is used as a test signal. Depending on the application however signals of individual frequencies or specific frequency bands can also be created. Furthermore it is also possible to generate more complex noises during a function test, e.g. to reproduce stored speech.

The audio signal used as a test signal primarily depends on the respective application as well as the technical outlay which is necessary for the purpose concerned. Simple analog test apparatus 1 can make do for example with a simple noise generator 141 as well as a comparator as an evaluation circuit 144. With the aid of DSP (digital signal processing) digital test apparatus can create and evaluate complex test signals.

The present example typically shows a very simple analog test circuit 14 with a noise generator 141 as a test signal generator. Such circuits can be manufactured very cost effectively. During a function test the signal created by the noise generator 141 is presented as acoustic noise via the loudspeaker 12 to the microphone 21 of the hearing device 2. The amplifier circuit 23 of the activated hearing device 2 then creates a response signal which is transmitted via the earpiece 22 of the hearing device to the test microphone 13 of the test apparatus 1. After an amplification of the response signal by an amplifier stage 142 the signal can be fed to a signal processing circuit 143 in which the response signal can be modeled for example by means of specific filters. The prepared response signal subsequently lies at an input of a comparator 144 which compares the amplitude of this signal with a predetermined test voltage. Depending on the result of this comparison, a specific voltage lies at the output of the comparator 144. The evaluation circuit is designed here so that the output signal causes a specific light emitting diode 15 to light provided the input signal exceeds a predetermined threshold value.

Preferably the evaluation circuit 144 merely distinguished between two states, namely “test passed” and “test not passed”. Depending on the level of the output signal, a red or a green light emitting diode is then activated (this is not shown in FIG. 2). A number of light emitting diodes are also conceivable however, with which the function state of the hearing device 1 can be represented in a more differentiated way. Also possible is for example an LCD display which can present further information. These solutions require further circuits which, for the sake of simplicity, are not shown here.

1.-13. (canceled)

14. An apparatus for testing a hearing device comprising:
a housing with a test area to accommodate a hearing device, wherein the test area has a microphone area and an earpiece area;
a signal generator and a loudspeaker, to create a defined acoustic test signal in the microphone area;
a microphone arranged in the earpiece area to detect an acoustic response signal emitted by the hearing device;
an evaluation circuit to determine a functional state of the hearing device based upon a response signal; and
a display device to display the functional state of the hearing device.

15. The apparatus as claimed in claim 14, wherein the display device indicates the functional state optically.

16. The apparatus as claimed in claim 14, wherein the display device indicates the functional state acoustically.

17. The apparatus as claimed in claim 14, wherein a display device has a first light source to indicate a first functional state and a second light source to indicate a second functional state, wherein the first functional state indicates passing a test and the second functional test indicates not passing the test.

18. The apparatus as claimed in claim 17, wherein the first light source has a green light emitting diode and the second light source has a red light emitting diode.

19. The apparatus as claimed in claim 14, wherein the signal generator generates a noise as a test signal.

20. The apparatus as claimed in claim 14, wherein the evaluation circuit has a comparator to determine the functional state of the hearing device based upon a comparison between a amplitude of the response signal and a predetermined voltage value.

21. The apparatus as claimed in claim 14, wherein the evaluation circuit determines the functional state of the hearing device based upon a comparison between the test signal and the response signal.

22. The apparatus as claimed in claim 14, wherein the microphone area and the earpiece area are acoustically screened from one another.

23. The apparatus as claimed in claim 22, wherein the earpiece area corresponds to the hearing device, to accommodate the earpiece with a positive fit to screen the earpiece acoustically from the microphone area.

24. The apparatus as claimed in claim 22, wherein the earpiece area corresponds to the hearing device, to accommodate the earpiece with a non-positive fit to screen the earpiece acoustically from the microphone area.

25. The apparatus as claimed in claim 14, wherein at least a part of the housing has a sound-deadening effect to screen the hearing device acoustically from its environment.

26. The apparatus as claimed in claim 14, wherein the housing is at least partly flexibly in the test area to allow a mechanical stress to be exerted from outside on the hearing device arranged in the test area during a function test.

27. The apparatus as claimed in claim 14, wherein the housing is a storage box for the hearing device.

28. A Method for testing a hearing device, comprising:
exerting a mechanical stress on the hearing device during testing the hearing device.

29. The method as claimed in claim 28, wherein a functional state of the hearing device is determined based upon a response signal to an acoustic test signal from a signal generator and a loudspeaker.

30. The method as claimed in claim 29, wherein the hearing device is a behind the ear hearing device.

31. The method as claimed in claim 30, wherein the mechanical stress is caused by a flexible device.
